(19) United States
(12) Patent Application Publication
(10) Pub. No.: US 2023/0326020 A1
(43) Pub. Date: Oct. 12, 2023

(54) SYSTEMS, DEVICES, AND METHODS FOR RECOGNIZING DEFECTS IN MEDICAL GRAFT PROCESSING

(71) Applicant: KERECIS HF, Isafjordur (IS)

(72) Inventor: Baldur KRISTJANSSON, Isafjordur (IS)

(21) Appl. No.: 18/190,512

(22) Filed: Mar. 27, 2023

Related U.S. Application Data
(60) Provisional application No. 63/323,754, filed on Mar. 25, 2022.

(51) Int. Cl. G06V 20/50; G06V 10/82; G06V 10/26; G06T 7/00; G06V 10/145

(52) U.S. Cl. CPC G06T 7/0012; G06V 10/145; G06V 10/26; G06V 10/82; G06V 20/50; G06T 2207/10024; G06T 2207/10064; G06T 2207/20021; G06T 2207/20084; G06T 2207/30088

(57) ABSTRACT

Systems and methods for identifying material components on graft products include an image capture device for obtaining image data of a graft product and a processor for processing image data with an artificial neural network, the artificial neural network localizing and classifying materials of the graft product from the image data. The image capture device may include an optical filter and an ultraviolet light source for ultraviolet fluoresce imaging of the graft product. Using the captured image data, the artificial neural network may identify unwanted materials on the graft product for subsequent removal, such as, for example, fascia or flesh on a piscine skin.

### TECHNICAL FIELD

The disclosure relates to a system and method for identifying material components in the processing of a scaffold material or a graft product for wound care and/or other tissue healing applications, and particularly using piscine skin.

### BACKGROUND

A variety of human, animal and synthetic materials are currently described or used in medical procedures to augment, repair, or correct tissue defects. The extracellular matrix (ECM) of vertebrates is a complex structural entity surrounding and supporting cells, and has been found to provide a particularly favorable scaffold material for skin graft products. ECM is composed of complex mixtures of structural proteins, the most abundant of which is collagen, and other specialized proteins and proteoglycans.

Piscine skin may be processed into a scaffold material including a largely intact acellular scaffold of natural biological ECM components. To be most effective, the native three-dimensional structure, composition, and function of the dermal ECM is essentially unaltered, and provides a scaffold to support cell migration, adherence, proliferation, and differentiation, thus facilitating the repair and/or replacement of tissue. These products must be suitably prepared as medical grade skin substitutes through various processing steps prior to use to prevent adverse indications, including infection, allergic reaction and the like.

A significant part of this processing is to thoroughly remove certain unwanted material from the inside of dried skin, namely, fascia and all flesh remains. While the fascia may be removed primarily for aesthetic reasons, it is critical to remove all flesh remains due to the possibility of allergic reactions to fish proteins in patients. Removal processes are generally performed by hand, where an expert technician uses a sharp tool to carefully scrape fascia and flesh remains from the skin. The process must be precisely performed to ensure unwanted materials are removed without damage to the ECM of the piscine skin and requires that the technician rely on visual inspection of the skin to estimate the appropriate degree of scraping required. Such work is time consuming, expensive, physically demanding, tedious, and subject to human error in locating and identifying unwanted materials on a piscine skin. Additionally, as the skilled technician removes the unwanted material, due to the physicality and extent of time of the removal processes, the technician often fatigues, which may greatly reduce the accuracy and consistency of the removal processes.

The inventors of the present disclosure have identified a significant need to properly identify and classify unwanted materials on the piscine skin remains a significant hurdle to improving quality control, process automation, and increasing the scale of the manufacturing process. The high cost of manual evaluation in the manufacturing process may limit the availability of graft products formed from piscine skin or otherwise render such products out of reach for the larger population. Further, the manual nature of such processes inevitably results in inaccuracies. With stringent medical safety requirements that increasingly require levels of accuracy and consistency achievable only by automated systems, rather than by human evaluation, the inventors have identified a need for a system and method for automatically and accurately locating and identifying components of the piscine skin is increasingly important.

Unfortunately, the difficulty of this task is compounded by the fact that, while having different textures, unwanted materials are similar in visual appearance to the accompanying piscine skin and often share the same milky white color. These obstacles render any assessment by existing image recognition approaches highly suspect. Accordingly, differentiating thin portions of white fascia and white flesh remains from a thin layer of white cleaned skin using a visual analysis remains a complex and difficult challenge. There is currently no improved system or method for preventing errors in this process, and quality control remains a yet unsolved problem that must rely on human visual inspection.

The identification, classification, and removal of unwanted materials from piscine skin thus remains a matter of subjective and sometimes arbitrary intuition, preferences, and user experience, rather than being an exercise in quantitative precision. The preparation of graft products using piscine skin may thus be subject to numerous errors and inefficiencies.

### SUMMARY

A system for identifying and distinguishing material components on graft products is provided. The system comprises an image capture device configured to obtain image data of a graft product and a processor configured to process the image data using an artificial neural network, the artificial neural network being configured to localize and classify materials of the graft product from the image data.

A method for identifying and distinguishing material components on graft products is also provided. The method comprises capturing with an image capture device an image of a graft product and using a processor to process the image data using an artificial neural network to localize and classify materials of the graft product from the image of the graft product.

A non-transitory hardware storage device is also provided having stored thereon computer executable instructions which, when executed by one or more processors of a computer, configure the computer to capture with an image capture device an image of a graft product and to use a processor to process the image data using an artificial neural network to localize and classify materials of the graft product from the image of the graft product.

Preferred embodiments of a system and method for identifying material components on graft products advantageously utilize a novel architecture that leverages ultraviolet fluorescence imaging, in embodiments utilizing fluorescence of the materials in the visible spectrum for image capture, in combination with specially adapted convolutional neural networks to localize and classify the material components of the graft products. The system and method of these or other disclosed embodiments may develop a comprehensive feature map of material components on a piscine skin to provide quality control in the removal of unwanted materials from a graft product. Using the comprehensive feature map in conjunction with automated processing tools, the system and method may automatically remove unwanted materials from a graft product.

### BRIEF DESCRIPTION OF THE DRAWINGS

These and other features, aspects, and advantages of the present disclosure will become better understood regarding the following description, appended claims, and accompanying drawings.

FIG. 1A is a diagram of a system for identifying material components on graft products according to an embodiment of the disclosure.

FIG. 1B is a diagram of a system for identifying material components on graft products according to another embodiment of the disclosure.

FIG. 1C is a diagram of a system for identifying material components on graft products according to another embodiment of the disclosure.

FIG. 2A is an image tile of a graft product captured by an image capture device according to an embodiment of the disclosure.

FIG. 2B is another image tile of a graft product captured by an image capture device according to another embodiment of the disclosure.

FIG. 3 is a flow diagram of a method for identifying material components on graft products according to an embodiment of the disclosure.

FIG. 4 is a diagram of a contracting path of an artificial neural network according to the embodiment of FIG. 3.

FIG. 5 is a diagram of final output step of an artificial neural network according to the embodiment of FIG. 3.

FIG. 6 is a diagram of an expanding path of an artificial neural network according to the embodiment of FIG. 3.

FIG. 7A includes one of a plurality of image tiles, an overlay image and a classified image according to the embodiment of FIG. 3.

FIG. 7B includes another one of a plurality of image tiles, an overlay image and a classified image according to the embodiment of FIG. 3.

FIG. 8 is a diagram of a system for identifying material components on graft products according to an embodiment of the disclosure including a computing device.

FIG. 9A is a diagram of a convolution operation according to an embodiment of the disclosure.

FIG. 9B is a diagram of another convolution operation according to an embodiment of the disclosure.

FIG. 10 is a diagram of symmetric pathways of an artificial neural network according to an embodiment of the disclosure.

FIG. 11 is a diagram of a system for identifying and removing material components on graft products according to another embodiment of the disclosure.

FIG. 12 is a flow diagram of a method for identifying and removing material components on graft products according to an embodiment of the disclosure.

### DETAILED DESCRIPTION

### Overview

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. It should be understood, however, there is no intention to limit the disclosure to the specific embodiments disclosed, but on the contrary, the intention covers all modifications, alternative constructions, combinations, and equivalents falling within the spirit and scope of the disclosure.

It will be understood that unless a term is expressly defined in this application to possess a described meaning, there is no intent to limit the meaning of such term, either expressly or indirectly, beyond its plain or ordinary meaning.

For the purposes of this application, in a preferred embodiment the terms “graft product,” may include “piscine skin,” “fish skin,” “acellular fish skin,” or similar include KerecisTM Omega3 Wound by Kerecis, Kerecis™ Omega3 acellular fish skin from the Atlantic cod (Gadus morhua), and any other fish skin grafts or similar to the foregoing. These graft products are subjected to processing that retains biological structure and bioactive compounds, including Omega3 polyunsaturated fatty acids (PUFAs), but removes allergenic and other unwanted components, and particularly removes tissue that would cause an immunological response from the receiving patient. Fish skins used in the preparation of graft products can vary in thickness, as can the fascia, flesh, or other unwanted material thereon, such as scales. Fish skins may have a thickness of about 0.35 mm to 2.25 mm while the thickness of unwanted materials thereon may range from about 0.15 mm to 1.75 mm. Preparation of a graft product from the fish skin may require removal of substantially all fascia, flesh, or other unwanted materials from the skin or the tissue to be used as the graft product. Although described as a preferred embodiment, the graft product is not limited to Atlantic cod (Gadus morhua), but may include any other harvested species of fish used for a skin graft or skin substitute product, such as tilapia, including Nile Tilapia (Oreochromis niloticus), or other fish species. In other embodiments, the “graft product” may be prepared from non-fish sources including, but not limited to, harvested mammalian skin, including porcine skin graft products, or human allograft or autograft, or cadaveric skin graft products. The graft products may ultimately be prepared as acellularized or decellularized graft products, or may be cellular skin graft products (i.e., a graft product with the skin cells remaining viable or intact). Further, the graft product may include a non-skin tissue to be used as a skin graft product, for example, a placental graft, wherein an undesired, second tissue or portion is to be removed from the tissue to be used as the graft product. Further, the graft product may include biological, synthetic, or hybrid skin substitutes wherein the graft product is inspected for an undesired tissue, portion, or material to be removed before being used as a graft product. Lastly, the graft product may include autograft, allograft, or xenograft products, and is not limited to skin graft products to be used on human patients, but also include autograft, allograft, or xenograft products used or prepared to be used on other non-human species, including horse, cattle, monkeys, rabbits, mice, rats, guinea pigs, or other species, mammal or non-mammal, to which a skin graft product is to be applied.

As described herein, a “convolutional neural network” refers to an artificial neural network for conducting an analysis, such as of an image, that is based on the shared-weight architecture of convolution kernels configured for pixel-by-pixel evaluation of an image. The convolutional neural network may adjust and improve kernel weights and biases through automated learning or training, for example using training datasets. In embodiments, the convolutional neural network may include a contracting path, or encoder, followed by a symmetric expanding path, or decoder, making the network an end-to-end fully convolutional neural network, containing convolutional layers and no dense layers.

### Various Embodiments and Components for Use Therewith

In preparation of graft products generally, as described above, for example, from piscine skins, it has been found that certain materials, such as fascia and flesh, can lead to unwanted reactions or results, such as immunological reactions and results, or can otherwise detrimentally affect the aesthetic or quality of the product. For example, in the case of piscine skin, portions or layers of fascia and flesh on the piscine skin can be extremely difficult to reliably differentiate from the acellular matrix of the piscine skin due to the small thicknesses involved and the shared milky white color of these components. Because of the challenges of accurately classifying and localizing these distinct material components using existing imaging approaches, evaluation of the components on a graft product, such as during scraping of piscine skins or after preparation of the graft product, are manually conducted, expensive, and often inaccurate, due to being poorly adapted to accurately distinguishing between the visually similar material components of piscine skins.

Further, manual evaluations of piscine skins are not capable of yielding actionable information regarding a type, quantity, and arrangement of a material of a piscine skin in an accurate, reproducible, and rapid manner.

In view of the foregoing, there is a need for a system and method for identifying material components on graft products that addresses the problems and shortcomings of existing approaches to identifying, assessing, and determining the location, quantity, and arrangement of material components on graft products, including the limitations of existing 2D image recognition approaches, as well as the costly, time-consuming manual identification of material components. The inventors have identified a need for a system of material identification that provides increased accuracy, speed and consistency in distinguishing between material components of graft products in order to provide actionable and quantifiable insights to a technician or automated processing system.

Embodiments of the system and method for identifying material components on graft products according to the present disclosure advantageously overcome the deficiencies of existing approaches to differentiating, identifying, and localizing material components on a graft product, such as fascia and flesh on a piscine skin, which are limited in accuracy and require tremendous time and effort to carry out.

In an embodiment of the system and method, ultraviolet fluorescence imaging and an improved neural network architecture are synergistically combined to classify and localize the material components of a graft product, preferably a piscine skin. The ultraviolet fluorescence imaging may be provided using an ultraviolet light source configured to illuminate a graft product, as well as using an image capture device configured to capture, store, and process an RGB (i.e. red, green, blue) image of induced fluorescence from the material components in the visible spectrum. In various embodiments, the ultraviolet light source may be configured to irradiate the graft product with light having a wavelength of about 365 nm to 395 nm. In one aspect, an ultraviolet light source may have a fixed center band of 395 nm, for example a light emitting diode having a fixed center band of 395 nm. Preferably, the wavelength of the ultraviolet light source is configured to irradiate the graft product without substantially heating the graft product. The image capture device may be integrated with a sensor device, such as a camera or similar device, and may process the image data using an application of a computing device configured to receive, store, process, and/or transmit the captured image. The captured or transmitted images may then be assessed to classify and localize material components of the graft product.

A system and method for identifying material components of a graft product leverages an RGB image of induced fluorescence from piscine skin in combination with an artificial neural network to segment, map, and identify material components in a space, such as fascia and flesh on a piscine skin. The system and method include an image capture device configured to capture an image, for example an RGB image, and a processor, configured to process the image data using the artificial neural network, preferably a convolutional neural network, the artificial neural network being configured to localize and classify materials of the graft product from the image data. The captured image may be an RGB or truecolor image, or any other suitable type of color image capturing ultraviolet induced fluorescence of a piscine skin, as would be understood by one skilled in the art from the present disclosure. The system and method mitigate the need to manually conduct a visual evaluation of material components of a piscine skin.

The image capture device may integrate an optical filter to filter incoming light for forming the captured image. Alternatively, the optical filter may be separate from (not integrated with) the image capture device but arrange such that incoming light passes through the optical filter before entering the image capture device. In varying embodiments, the optical filter may comprise a long-pass filter that reflects short wavelengths while transmitting long wavelengths. In one aspect, a cut-on wavelength of the long-pass filter may be in the range of about 375 nm to 675 nm, 400 nm to 600 nm, 400 nm to 500 nm, 425 nm to 625 nm, or for some embodiments about 435 nm. The optical filter may have a transmittance in the selected wavelengths of about 85%. The optical filter may necessarily be present as a hardware component or a physical filter on the image capture device, as images captured without a physical optical filter are so saturated with light that distinguishing between the material components of the graft product becomes impracticable. Further, optical filtering or additional optical filtering may be provided through digital processing of image data obtained the image capture device.

The system and method embodiments may provide a pixel-by-pixel evaluation of the captured image to mark and classify a physical material at each position of the graft product. In varying examples, each pixel may be configured to correspond to an area of the graft product between about 200 and 800 µm² in size, between about 300 and 600 µm² in size, or for some embodiments about 400 µm² in size. Alternatively, a pixel resolution of at least 200 pixels/mm² may be used, more particularly at least 400 pixels/mm², at least 600 pixels/mm², at least 800 pixels/mm², at least 1000 pixels/mm², at least 1500 pixels/mm², or at least 2000 pixels/mm². Advantageously, the pixel-by-pixel evaluation of the captured image according to disclosed system and embodiments enable the detection of even very small amounts of unwanted material, ensuring higher quality and accuracy in the resulting graft products.

The system and method may include a segmentation of the captured image into a plurality of image tiles for input to the artificial neural network. The image tiles may be of equal size, for example 512×512 pixels, and the captured image may be resized as required to enable the segmentation of the image tiles. Preferably, the plurality of image tiles comprises at least 20 individual tiles, at least 25 individual tiles, at least 30 individual tiles, at least 35 individual tiles, or for some embodiments 35 individual tiles. The image tiles may also be employed to train and retrain a learning artificial neural network, such as by allowing a convolutional neural network to make adjustments to kernels, kernel biases, or kernel weights in respective convolution layers based on feedback from training datasets.

In a first aspect, the system and method provide a first phase of a stepped contracting path or encoder for contextualizing each image tile, the stepped contracting path including a plurality of contracting steps. Each step of the stepped contracting path may include a first convolutional layer configured to filter each pixel of the captured image to form feature maps for input to additional layers, followed by a first rectifier layer which determines for each pixel on the feature maps from the first convolutional layer whether a feature is present. Each step may further include a second convolutional layer followed by a second rectifier layer, the first rectifier layer providing an input for the second convolutional layer. Each of the plurality of steps may also include storing a resulting contracted output or contracted feature map from the second rectifier layer, such as a resulting feature map of the material components on the graft product. A pooling layer may be provided in each step of the stepped contracting path for selecting prominent features of the stored contracted feature map as inputs for subsequent layers and/or steps.

According to varying embodiments, the described rectifier layers of the artificial neural network may comprise non-linear rectifier layers. The non-linear rectifier layers may include a threshold operation, for example which returns a zero for values less than zero but directly returns an input value for values over zero. Accordingly, the non-linear rectifier layers may comprise activation functions taking the calculated values from a preceding convolution layer and transforming the values to an output. Preferably, the rectifier layers may comprise a non-linear rectifier (ReLu) type activation.

In a second aspect, the system and method provide a second phase of a symmetric stepped expanding path or decoder for precisely localizing features of the captured image, the stepped expanding path including a plurality of expanding steps. Each step of the symmetric stepped expanding path may include a first convolutional layer followed by a first rectifier layer and a second convolutional layer followed by a second rectifier layer, the first rectifier layer providing an input for the second convolutional layer. Each step may further include an up-sampling layer following the second rectifier layer, the up-sampling layer forming an up-sampled feature map. Each step of the symmetric stepped expanding path may include a concatenation or stacking operation of the up-sampled feature map with a stored contracted feature map. The up-sampled feature map and the stored contracted feature map selected for the concatenation operation may be selected based on having a common or same size.

In a third aspect, the system and method provide a third phase of an output operation or step, comprising a first convolutional layer followed by a first rectifier layer and a second convolutional layer followed by a second rectifier layer. The output operation further includes a sigmoid layer following the second rectifier layer.

The image capture device and/or computing device may be configured to conduct the above-mentioned and other steps described herein locally. The computing device may comprise a storage, a processor, a power source, and an interface. Instructions on the storage may be executed by the processor so as to utilize one or more neural networks as described herein to capture an image, classify, and localize material components of a graft product. While in embodiments the above steps are performed locally, it will be appreciated that one or more of the steps described herein may be performed by cloud computing, with captured images transmitted to a remote server, with a processor located on the remote server configured to classify and localize material components of a graft product.

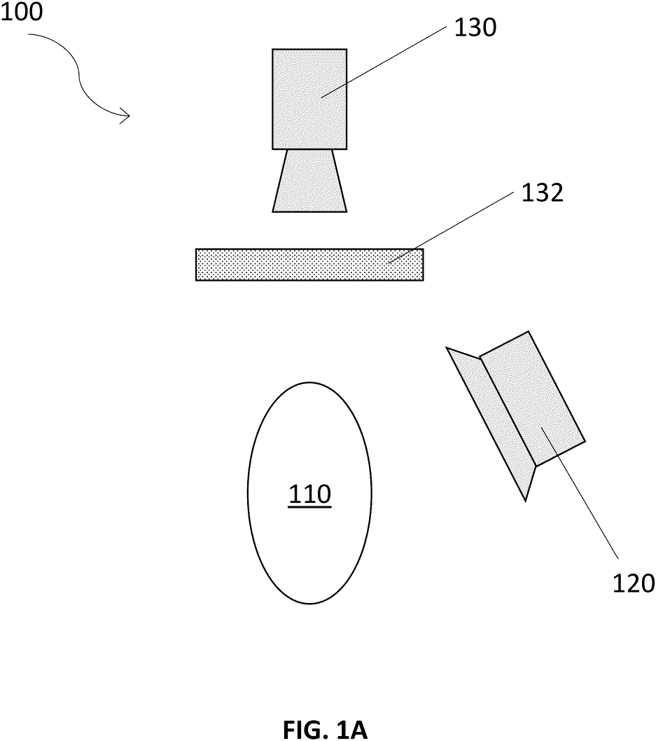

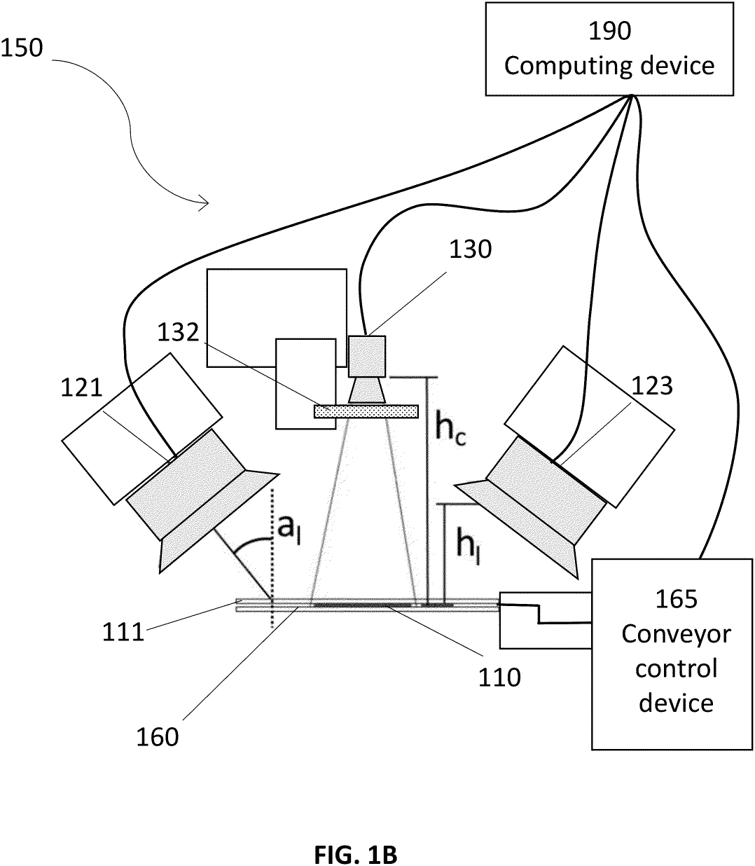

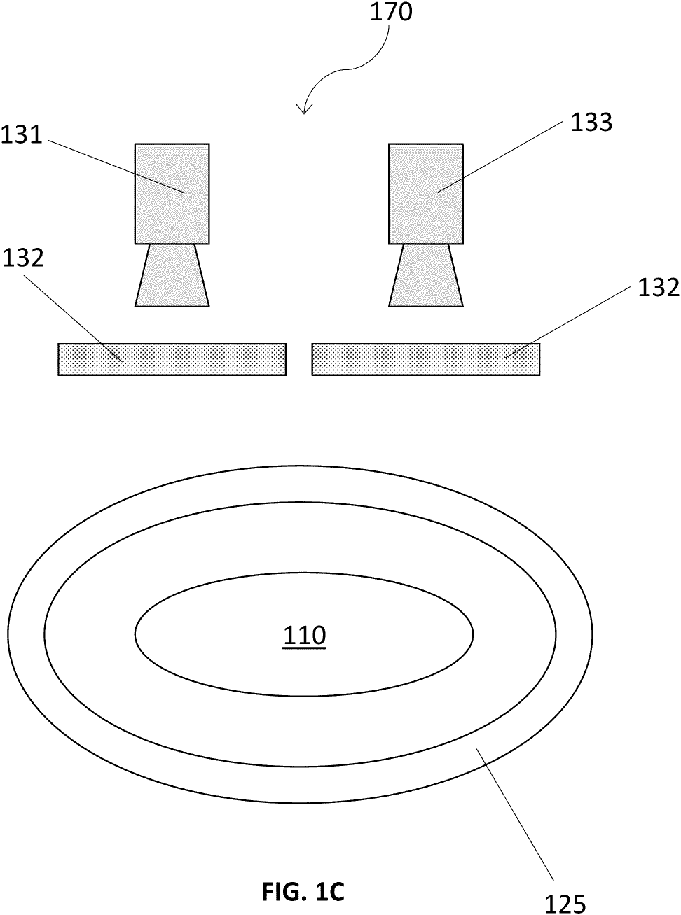

FIG. 1A is a schematic diagram of a system 100 for identifying material components of a graft product 110 according to an embodiment of the present disclosure in what may be considered its most basic form. The system 100 includes an ultraviolet light source 120 configured to illuminate the graft product 110 and an image capture device 130 configured to capture an image of the graft product 110. The captured image includes an induced fluorescence of the graft product 110. The image capture device 130 may comprise an optical filter 132 configured to filter incoming light below a predetermined wavelength from entering the image capture device.

FIG. 1B is a schematic diagram of another embodiment of a system 150 for identifying material components of a graft product 110. The system 150 includes a first ultraviolet light source 121 and a second ultraviolet light source 123, each ultraviolet light source 121, 123 being configured to illuminate the graft product 110 and an image capture device 130 configured to capture an image of the graft product 110. In one embodiment, image capture device 130 may include a Sony IMX219 8-megapixel sensor, or an equivalent imaging device. Although an 8 megapixel sensor may be used, greater resolution can be obtained with a larger megapixel sensor, such as an 12 megapixel sensor, 20 megapixel sensor, or a 30 or 40 megapixel sensor. Image capture device 130 may be configured to obtain still images or video images, or both, of the graft product as the graft product is conveyed in a direct transverse to the imaging direction of the image capture device 130 by a conveyor 160, on which the graft product 110 lays. In certain embodiments, the graft product 110 may be secured in place or on the conveyor 160 by restraining elements, such as clips, bars, suction devices, and/or a transparent cover, such as a plexiglass sheet 111.

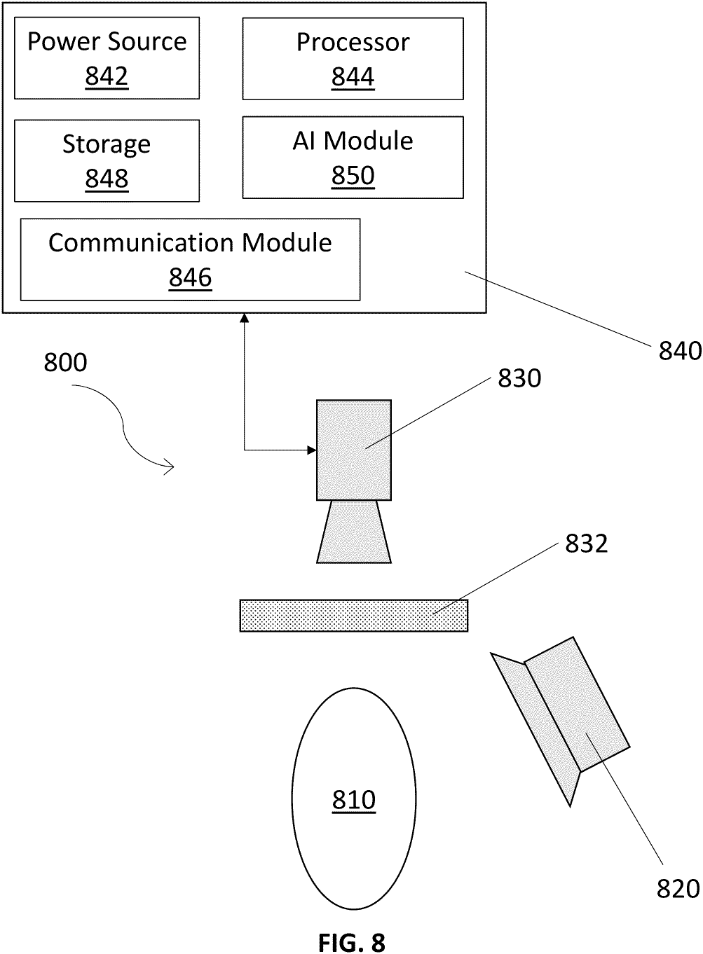

The conveyor 160, which may be a conveyor belt, is controlled by conveyor control device 165, which may include a conveyor drive system. Conveyor control device 165 can alter the speed and direction of the conveyor 160. Additional, conveyor control device is controlled by computing device 190. The captured image includes an induced fluorescence of the graft product 110. The image capture device 130 may comprise, or the system 150 may comprise, an optical filter 132 configured to filter incoming light below a predetermined wavelength from entering the image capture device. System 150 includes a computer or computing device 140, which will be described in further detail herein (for example, in the embodiment shown in FIG. 8 below).

Computing device 190 receives image data from image capture device, for example, in the form of still image data or video image data. Computer device may also control first ultraviolet light source 121 and second ultraviolet light source 123. Although hardwire connections between computing device 190 and the first and second ultraviolet light sources 121, 123, and image capture device 130, and conveyor control device 165 may be included in various embodiments, data between these components may be transmitted via wireless communication, such as a Bluetooth. Further, although FIG. 1B shows an embodiment with a data connection (hardwire or wireless) between the computing device 190 and the first and second ultraviolet light sources 121, 123, and image capture device 130, and conveyor control device 165, the computing device 190 does not necessarily require control of the first and second ultraviolet light sources 121, 123 or of the conveyor control 165. What is particularly significant is that computing device 190 receives image data from image capture device 130.

As further described herein, computing device 190 includes an input and output, one or more processors, and a memory storage. Further, in another embodiment, computing device 190 is physically coupled to image capture device 130 such that computing device 190 and image capture device 130 are provided in an integral unit.

In the embodiment of FIG. 1B, first ultraviolet light source 121 is arranged to emit ultraviolet light at an angle (al) relative to a perpendicular direction from a plane of the conveyor 160. Second ultraviolet light source 123 may arranged to emit ultraviolet light at an angle similar to angle (al) but on an opposite side conveyor 160. Or second ultraviolet light source 123 may be arranged at an angle (b1) different than angel (al). Angle (al) and angle (bl) may be in the range of 0° to 60° or 0° to 45° relative to the perpendicular direction, in some embodiments within the range of 0° to 30° or 30° to 60°, or in a specific embodiment about 45°. Similarly, second ultraviolet light source 123 is arranged at a height (hl) above the plane of the conveyor 160. First ultraviolet light source 121 may be arranged at a similar height above the plane of the conveyor 160. Or first ultraviolet light source 121 may be arrange an a second height (h2) different than the first height (hl) of the second ultraviolet light source 123. Height (hl) and height (h2) may be in the range of 4 cm to 12 cm or 6 cm to 10 cm, or in specific embodiments about 8 cm. Additionally, image capture device is arranged at a height (hc) above the plane of the conveyor 160. In varying embodiments, the height (hc) may be less than 60 cm or less than 30 cm, more particularly less than 12 cm or less than 6 cm, or between 2 cm and 8 cm, more particularly between 4 cm and 6 cm, or may be about 5 cm, more particularly about 5.3 cm, as may be determined according to the requirements of the image capture device. In some embodiments, components of the image capture device may be provided or enclosed in a housing or frame, such as for limiting extraneous light from the environment or otherwise supporting components of the image capture device.

Upon receiving image data from image capture device 130, computing device 190 stores the image data in a memory storage of the computing device. One or more processors of computing device 190 may perform a segmentation of the captured image into a plurality of image tiles for input to the artificial neural network. The image tiles may be of equal size, for example 512×512 pixels, and the captured image may be resized as required to enable the segmentation of the image tiles. Preferably, the plurality of image tiles comprises at least 20 individual tiles, at least 25 individual tiles, at least 30 individual tiles, at least 35 individual tiles, or for some embodiments 35 individual tiles. The image tiles may also be employed to train and retrain a learning artificial neural network, such as by allowing a convolutional neural network to make adjustments to kernels, kernel biases or kernel weights in respective convolution layers based on feedback from training datasets.

FIG. 1C is a schematic diagram of another embodiment of a system 170 for identifying material components of a graft product 110. The system 170 includes a plurality of image capture devices, including at least a first image capture device 131 and a second image capture device 133, each image capture device 131, 133 being configured to capture an image of the graft product 110. An ultraviolet light source 125 may be provided in the system 170 in the form of a diffused circular light or a diffused light of another shape (e.g., square shaped, bar shaped, etc.), the ultraviolet light source 125 illuminating the graft product 110. Each of the plurality of image capture devices 131, 133 may include or be provided with a corresponding optical filter 132, as discussed in detail in other embodiments of the disclosure.

In one embodiment, image capture devices 131, 133 may each include a 12-megapixel sensor, or an equivalent imaging device. Image capture devices 131, 133 may be configured to obtain still images or video images, or both, of the graft product, such that the image data captured by each image capture device 131, 133 may be processed individually by the neural network or merged prior to processing. The use of two or more image capture devices 131, 133 may be configured to allow imaging a graft product 110 at one time, without the need to move the graft product 110.

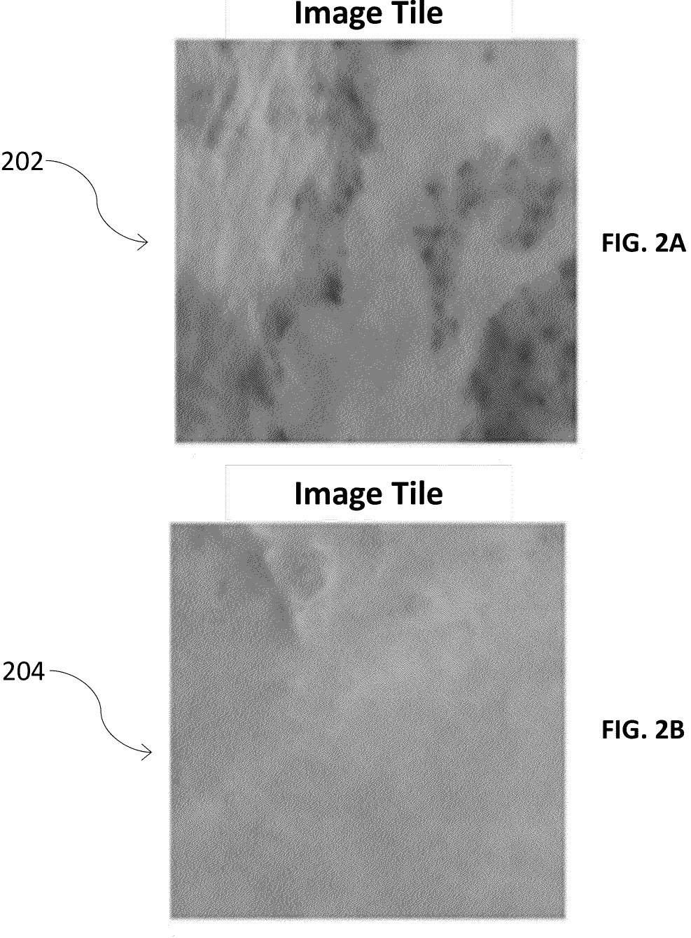

FIGS. 2A and 2B include examples of image tiles 202, 204 from a captured image of a graft product according to the current disclosure. In the illustrated embodiment, the image tiles 202, 204 show material components including fascia, flesh and skin. As a consequence of combined effects of the ultraviolet fluorescence and the optical filter of the image capture device 130, fascia can be seen as dark blue or purple, flesh is seen as a dark yellow, and skin can be seen as light blue. However, accurately differentiating and localizing fascia, flesh and skin from the image tiles 202, 204 of the captured images remains a challenge given the similarities in color and lack of contrast between individual materials components thereon. As such, advantageous localization and classification of materials in the image tiles according to the present disclosure requires cooperation with an artificial neural network.

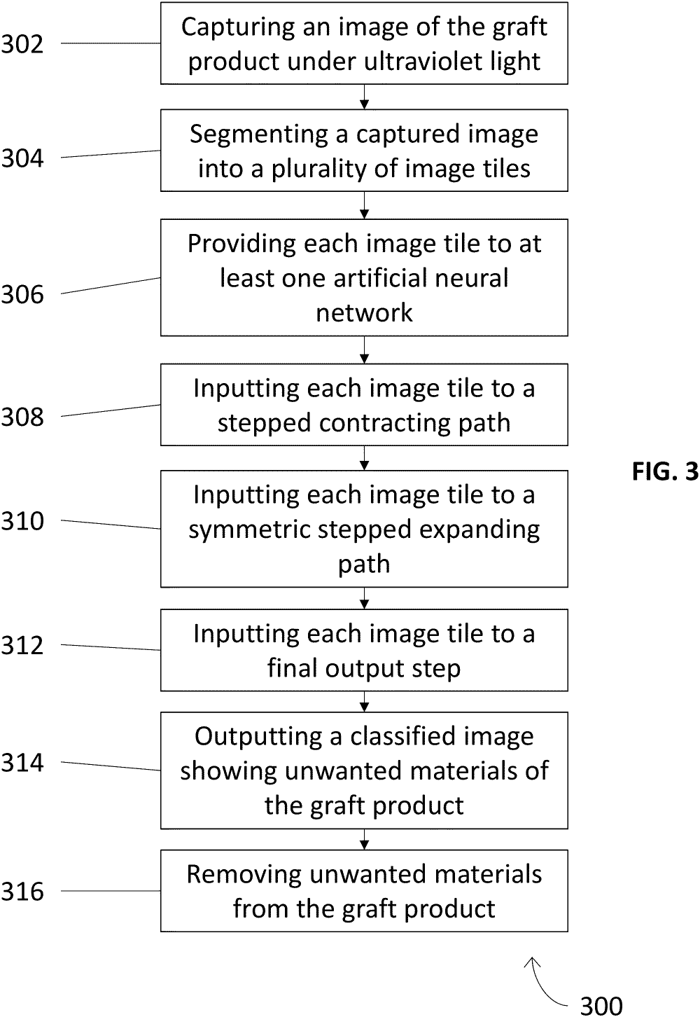

FIG. 3 is a flow diagram of a method 300 for a pixel-by-pixel evaluation of the captured images in order to mark and classify a physical material at each position of the graft product according to embodiments of the disclosure. In an initial step 302, a graft product is provided to the system 100 and an image of the graft product is captured under ultraviolet light. For evaluating the captured image, the captured image may be segmented 304 into a plurality of image tiles of equal size. In the illustrated examples of FIGS. 2A and 2B, each image tile has dimensions of 512×512 pixels for each of red, green and blue, such that each image tile forms a 512×512×3 matrix. Each entry in the matrix may have an 8-bit value ranging from 0 to 255. Each image tile may be input 306 to an artificial neural network for classifying and localizing component materials shown in the captured image of the piscine skin.

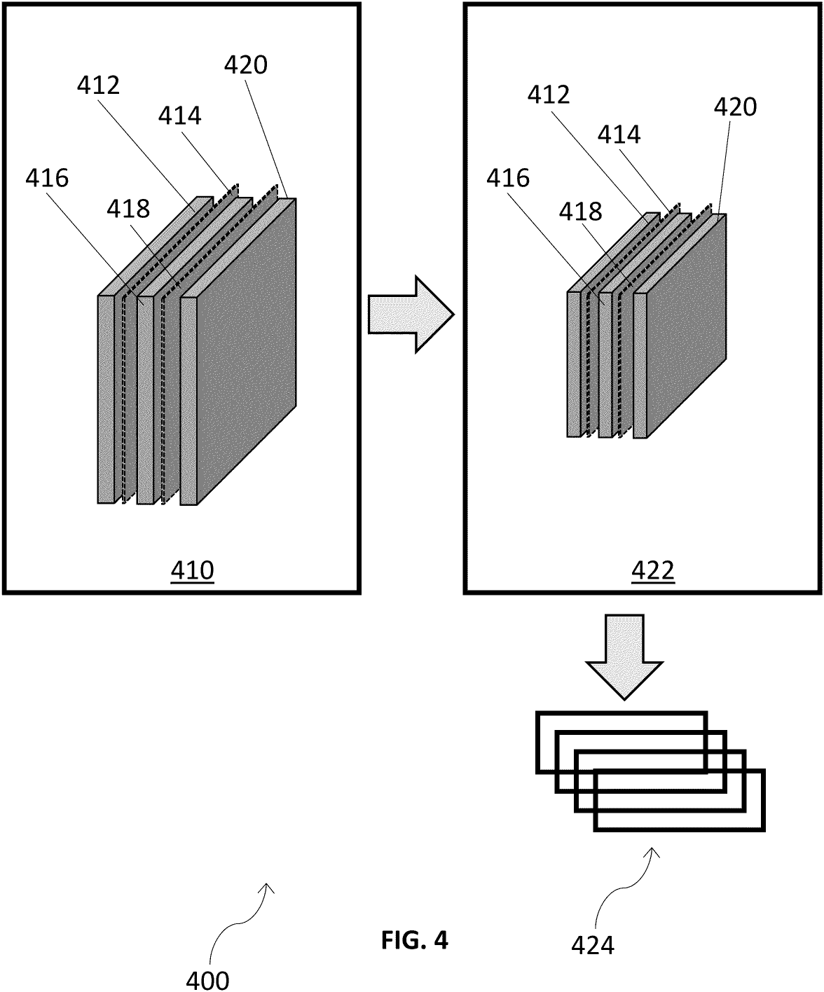

In a first aspect, the artificial neural network may comprise a convolutional neural network, the method comprising inputting each image tile to a stepped contracting path 308, or encoder, of the convolutional neural network for contextualizing each image tile in a first phase. As shown in FIG. 4, the stepped contracting path 400 may include a plurality of contracting steps 410, 422, 424, each step comprising a first contracting convolutional layer 412 configured to filter each pixel of the captured image to form feature maps for input to additional layers, followed by a first contracting rectifier layer 414 which determines for each pixel on the feature maps from the first contracting convolutional layer 412 whether a feature is present. Each step may further include a second contracting convolutional layer 416 followed by a second contracting rectifier layer 418, the first contracting rectifier layer 412 providing an input for the second contracting convolutional layer 416. Each of the plurality of steps may also include storing a resulting contracted output or contracted feature map from the second contracting rectifier layer 418, such as a feature map of the material components on the graft product. A pooling layer 420 may be provided in each step of the stepped contracting path to select prominent features of the stored contracted feature map as inputs for subsequent layers. The step 410 of the contracting path 400 may be repeated multiple times with a contracted feature map from a previous step provided as an input to the first contracting convolutional layer 412 of a following step 422, 424. As shown in FIG. 4, the contracting path may comprise a plurality of steps 424, preferably six steps.

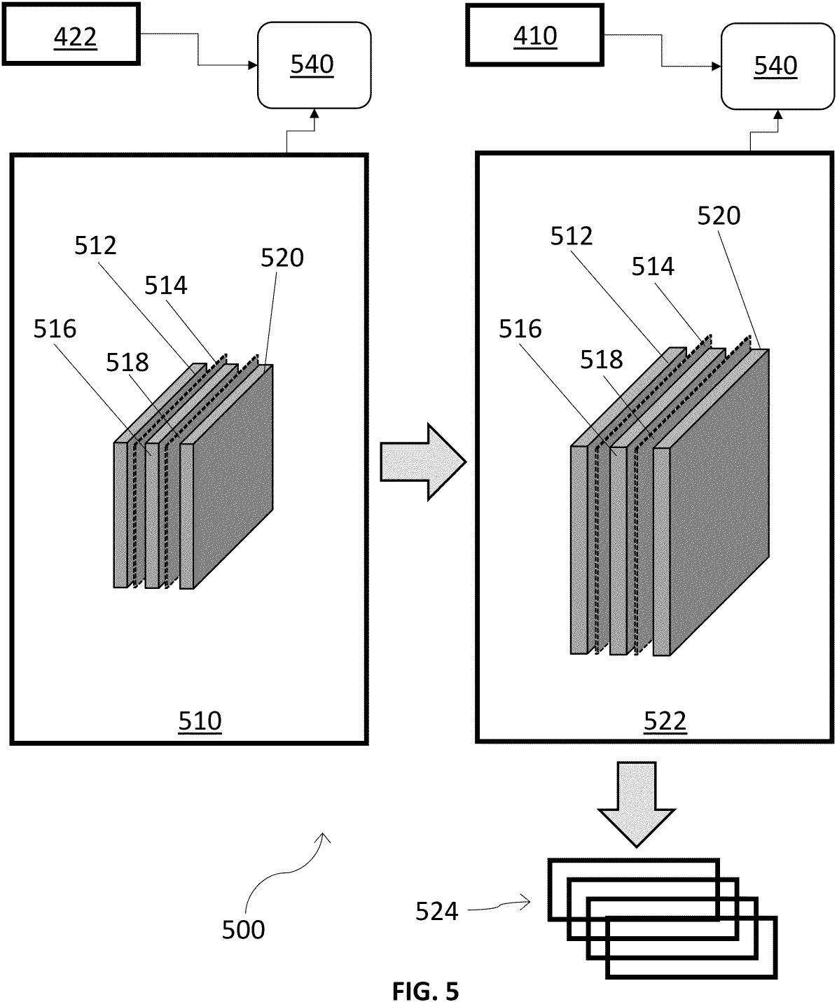

In a second aspect, the system and method comprise a second phase of the convolutional neural network, including inputting each image tile to a symmetric stepped expanding path 310 or decoder for precisely localizing features of the captured image, the stepped expanding path 500 including a plurality of expanding steps 510, 522, 524. Each step 510 of the symmetric stepped expanding path 500 may include a first expanding convolutional layer 512 followed by a first expanding rectifier layer 514 and a second expanding convolutional layer 516 followed by a second expanding rectifier layer 518, the first expanding rectifier layer 514 providing an input for the second expanding convolutional layer 516. Each step may further include an up-sampling layer 520 following the second expanding rectifier layer 518, the up-sampling layer 520 forming an up-sampled feature map. Each step of the symmetric stepped expanding path 500 may include a concatenation or stacking operation 540 of the up-sampled feature map with a stored contracted feature map from a step of the contracting path 400. The up-sampled feature map and the stored contracted feature map selected for the concatenation operation 540 may be selected based on having a common or same size. The step 510 of the expanding path 500 may be repeated multiple times with an expanded feature map from a previous step provided as an input to the first expanding convolutional layer 512 of the following step 522, 524. As shown in FIG. 5, the expanding path 500 may comprise a plurality of steps 524, preferably an equal number of steps as the contracting path 400, for example six steps.

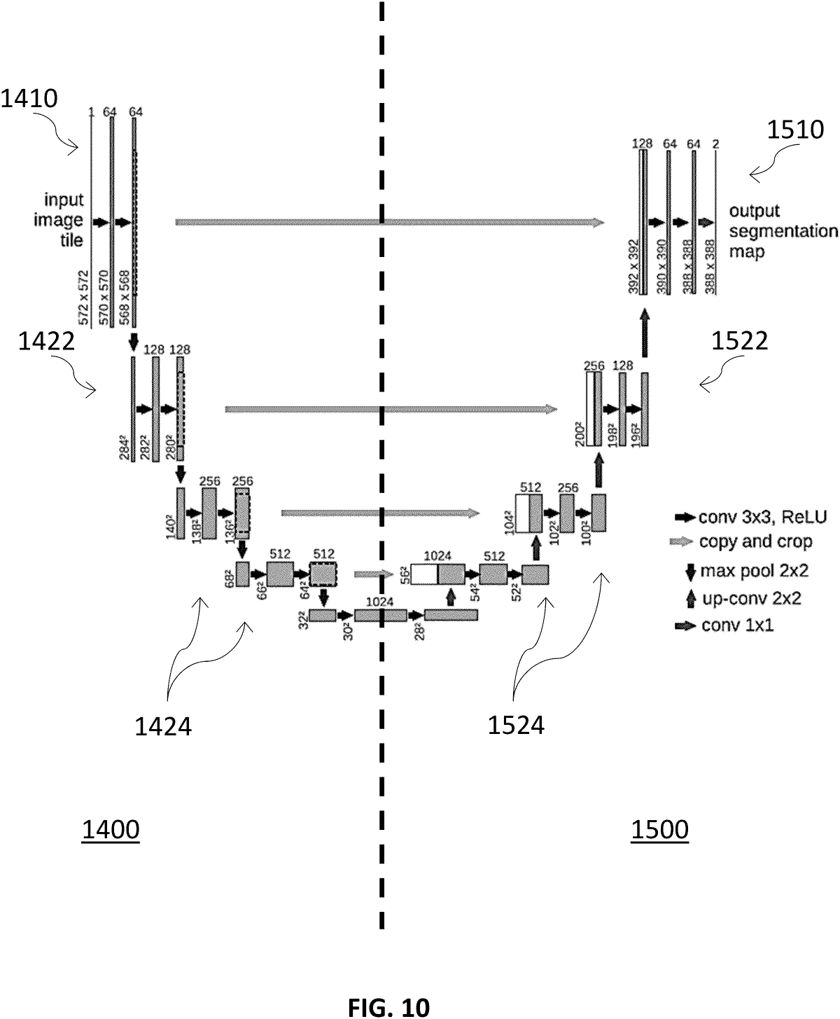

As may be seen in a comparison of FIG. 4 and FIG. 5, the contracting path 400 and the expanding path 500 are substantially symmetrical paths. In one aspect, a convolutional neural network of some embodiments may have a U-shaped architecture as illustrated in FIG. 10. In the diagram of FIG. 10, steps 1410, 1422, 1424, 1510, 1522, 1524 may correspond to steps 410, 422, 424, 510, 522, 524 of FIGS. 4 and 5, the contracting path 1400 and the expanding path 1500 forming symmetric sides of the U-shaped architecture. It should be noted that the embodiment of FIG. 10 shows only a 4-step deep network for ease of understanding. Preferably, artificial neural networks of the current disclosure include a larger 6-step deep network, as detailed in other embodiments.

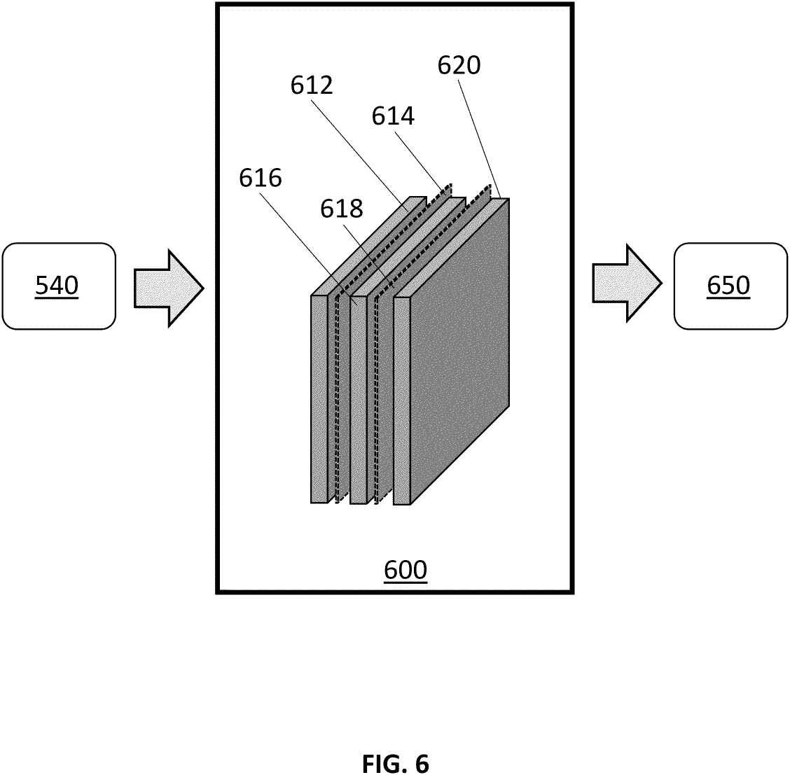

In a third aspect, the system and method provide for a third phase of the neural network including inputting the concatenated or stacked output from the up-sampled feature map and the stored contracted feature map to an output step 312. As illustrated in FIG. 6, the output step 600 may comprise a first output convolutional layer 612 followed by a first output rectifier layer 614 and a second output convolutional layer 616 followed by a second output rectifier layer 618. The output step 600 may include a sigmoid layer 620 following the second output rectifier layer 618. The sigmoid layer 620 may comprise an activation function configured to map all pixel values to values between zero and one, such that a binary determination may be made for each pixel whether unwanted material is present. The output step 600 provides an output 314 in the form of a classified image 650 identifying and localizing material components of the graft product.

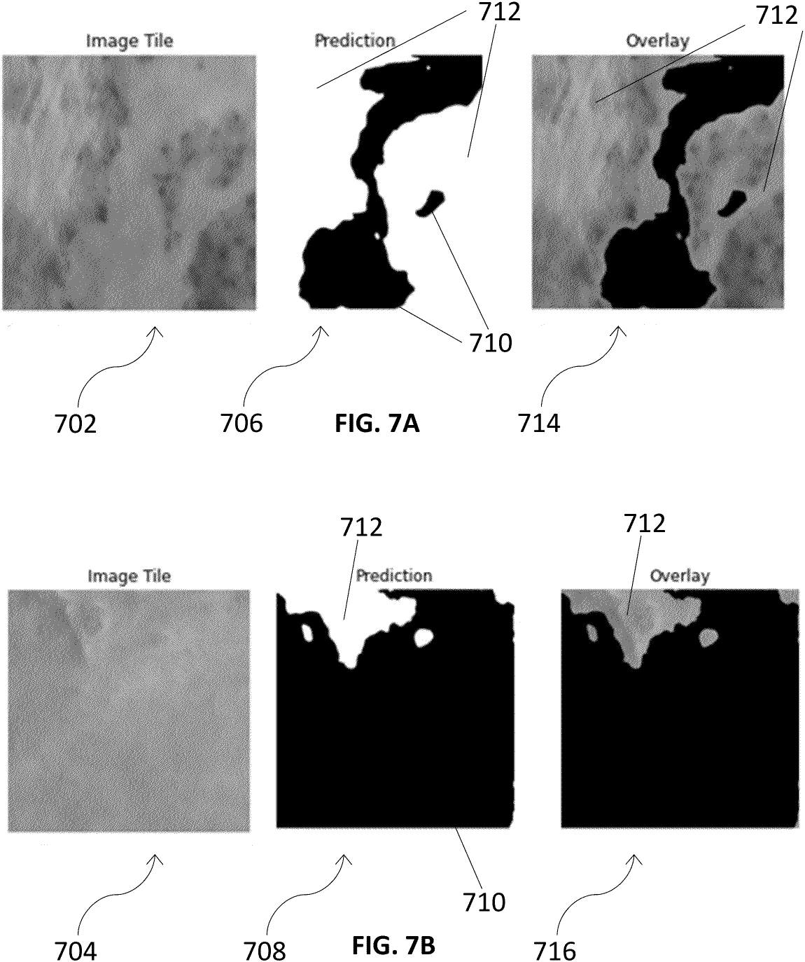

The classified image may comprise the captured image with an overlay distinguishing unwanted materials, such as fascia and flesh, from a piscine skin. FIGS. 7A and 7B show captured images 702, 704, which correspond to the RGB images of FIGS. 2A and 2B, the captured images 702, 704 being captured by the image capture device of the described embodiments. The artificial neural network of the current disclosure may be configured to prepare an overlay image 706, 708 including a predicted classification and localization of unwanted materials and piscine skin from the captured images 702, 704. In the overlay images 706, 708, pixels 710 classified as piscine skin are filled and appear black, while pixels 712 classified as unwanted materials remain as open or transparent areas. As discussed above, the sigmoid layer 620 may be configured to map all pixel values to values between zero and one for this purpose, such that all values less than 0.5 are shown as black and all values greater than 0.5 are shown as white or transparent to return a binary image of the prediction. In other multiclass embodiments, such as distinguishing each of flesh and fascia both from skin and from each other, the final convolutional operation may use the same number of filters as the number of classes of defects and the sigmoid layer 620 may be replaced with an argmax or a softmax activation function to return a score-per-class for each pixel. The classified images 714, 716 include a combination of the captured images 702, 704 and the overlay images 706, 708. As would be apparent to one skilled in the art, the classified images 714, 716 reveal each pixel 712 where unwanted materials remain.

Turning back to the method 300 of FIG. 3, the classified images 714, 716 may be used to guide removal of unwanted materials from the graft product 316. In various embodiments, the removal of the unwanted materials may be performed manually or by an automated machine or process. Preferably, the method 300 may be repeated as an iterative process to ensure preparation of the piscine skin free from unwanted materials.

Embodiments of a method and system according to the current disclosure may further include a user interface configured to display the classified images 714, 716 to a user. The classified images may be labeled by the processor to output a labeled image including, for example, bounding boxes, tags, or alterations to color configured to emphasize the location of unwanted materials for removal. In a similar manner, the user interface may provide a comparison between a series of classified images separated by steps of removing the unwanted materials from the graft product, so as to permit a user to comprehend progress made over time. Varying embodiments of a user interface may include varying input and output devices for facilitating interaction with a user, including a display screen, touch screen, speakers, audible alarms, indicator lights, or the like, including conventional control devices such as a keyboard, control panel, computer mouse or similar devices.

FIG. 8 is a diagram of a system 800 including a computing device 840 for identifying material components of a graft product 810 according to an embodiment of the present disclosure. The system 800 includes an ultraviolet light source 820 configured to illuminate the graft product 810 and an image capture device 830 configured to capture an image of the graft product 810. The image capture device 830 may comprise an optical filter 832 configured to filter incoming light below a predetermined wavelength from entering the image capture device. The computing device 840 may comprise a power source 842, a processor 844, a communication module 846, and a storage 848.

The storage 848 may comprise instructions for operating a system for identifying material components on graft products stored thereon in a non-transitory form that, when executed by the processor 844, cause the processor 844 to carry out one or more of the steps described herein, in particular receiving image data and localizing and classifying materials of the graft product from the image data. The computing device 840 may comprise one or more AI modules 850 configured to apply the artificial neural network described above regarding the embodiments of FIGS. 1-7.

In embodiments, the computing device 840 may be configured to operate the image capture device to capture image data, such as RGB image data, and to process locally and in substantially real time the captured image data using the artificial neural network stored on the AI module 850 to output the classified and localized images, as described above.

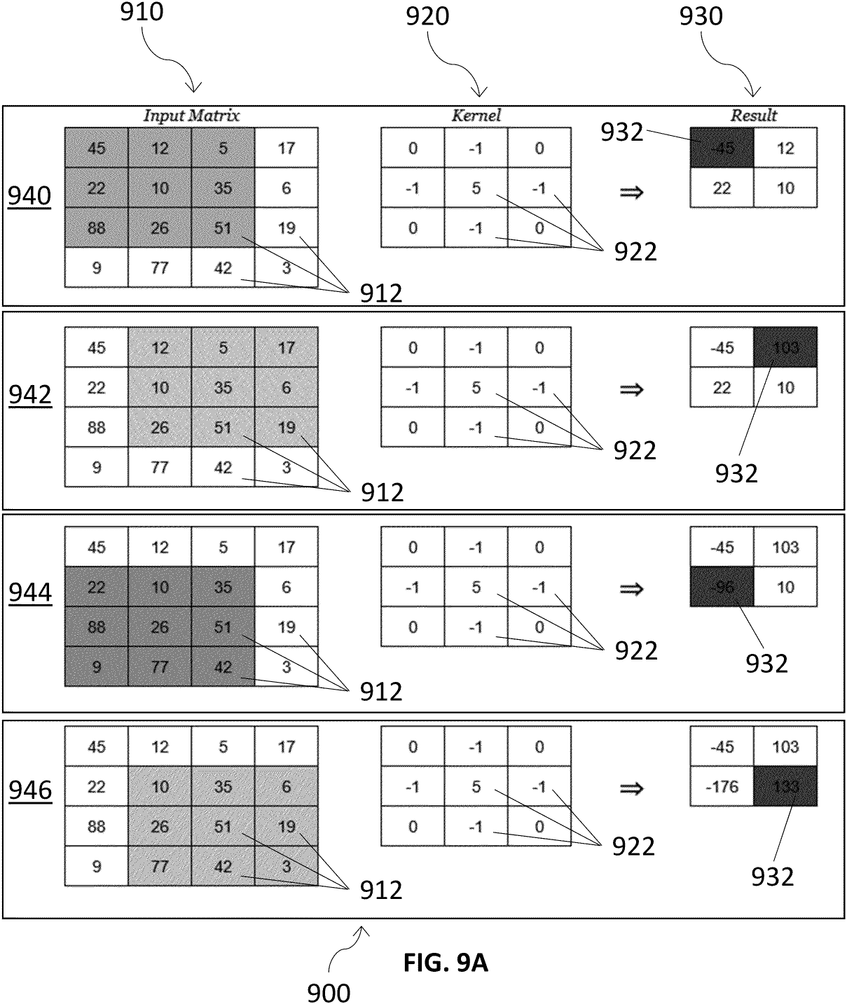

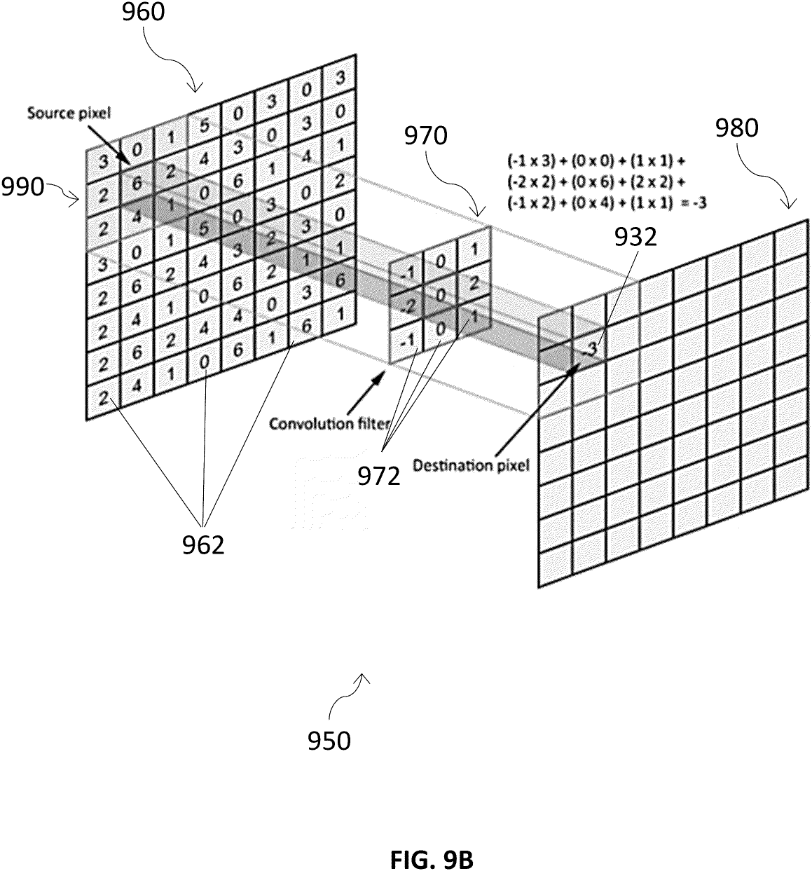

As described above with respect to FIG. 4 and FIG. 5, an artificial neural network according to embodiments of the current disclosure may include a plurality of convolutional layers 412, 416, 512, 516, 612, 616 configured to filter each pixel of the captured image to form feature maps for input to additional layers. FIG. 9A is a diagram of a convolution operation 900 including an input matrix 910, a kernel 920, and a result 930. An input matrix 910 according to varying embodiments of the disclosure may comprise image data captured from a graft product. In an embodiment, the image data may comprise color intensity values 912 for each pixel location of the captured image, for example an 8-bit value ranging from 0 to 255. While shown as a simplified, two-dimensional input matrix 910 in FIG. 9A having dimensions of only 4×4 for ease of understanding, image data in the disclosed embodiments may preferably comprise a three-dimensional matrix including color intensity values 912 for each of intensities of red, green and blue in an RGB image.

In one embodiment, image data of a captured image may comprise an 8-megapixel image of 3280×2190 resolution. The captured image may be resized to 3584×2560 to facilitate the creation of equally sized image tiles therefrom, for example, by cropping the resized image into exactly 35 individual image tiles of 512×512 pixels in size. In this example, the individual image tiles comprise a three-dimensional input matrix having dimensions of 512×512×3, 512×512 comprising pixel locations in the image and three separate values in the third dimension being intensities of red, green, and blue color in the image data.

Turning to FIG. 9A, the kernel 920 may be applied to the input matrix 910 to enhance features of the input matrix 910 in the output result 930. The kernel 920 may include a plurality of predetermined weight values 922 for transforming the color intensity values 912 of the input matrix 910. As discussed with respect to the illustrated input matrix 910, while depicted as a two-dimensional matrix in FIG. 9A, a kernel 920 in the disclosed embodiments may preferably comprise a three-dimensional matrix corresponding to the three-dimensional input matrix. The kernel 920 is applied to the input matrix 910 with a fixed pathway and stride. For a three-dimensional matrix of the current disclosure, the kernel may move from front to back through the color dimensions and move from left to right and top to bottom with a predetermined stride. According to the two-dimensional illustration of FIG. 9A, the kernel 920 may be moved from a first position 940 to a second position 942, a third position 944, and a fourth position 946.

An entry 932 in the convoluted result 930 for each position 940, 942, 944, 946 is calculated based on an operation between the color intensity values 912 of the input matrix 910 and the predetermined weight values 922 of the kernel 920. According to the illustrated example of FIG. 9A, the entry 932 of the convoluted result for the first position 940 of the kernel 920 may be calculated as:

$$\begin{matrix}45 ∗ 0 + 12 ∗ \left(- 1\right) + 5 ∗ 0 + 22 ∗ \left(- 1\right) + 10 ∗ 5 + 35 ∗ \left(- 1\right) + 88 ∗ 0 \text{+} \\ 26 ∗ \left(- 1\right) + 51 ∗ 0 = - 45\end{matrix}$$

The entries 932 of the result 930 may cumulatively form feature maps, such as a contracted feature map or an expanded feature map in respective pathways, for input to additional layers of the artificial neural network. In an example according to the depicted embodiment of FIG. 9A, a convolution operation for a three-dimensional matrix may be conceived from repeating the illustrated convolution operation three times, one for each input matrix of red, green, and blue. Such an example of a convolution operation, the embodiment of FIG. 9A repeated three times for each input matrix of red, green, and blue, comprises a single filter channel and corresponds to a feature map. Where additional filter channels are provided additional feature maps result, providing increased sensitivity and detail in detecting features in the image data. The feature maps may then put through a rectified non-linear unit layer, as shown in FIGS. 4-6, which decides, based on scores from the convolutions, whether a feature is present at a given location in the image. Pooling may be used to select the largest values on the feature maps and use them as inputs to subsequent layers, thus further enhancing the most prominent features.

In methods and systems of the current disclosure, a first contracting step may include 64 filter channels in each convolution layer, the number of filter channels doubling at each contracting step. As such, where there are six contracting steps, the convolution layers of the final contracting step may include 4,096 filter channels. A first expanding step may then halve the number of filter channels in each convolution layer until the final expanding step has the same number of filter channels in each convolution layer as the first contracting step. An output step may include the same number of filter channels as a number of classes of material desired to be identified, these filter channels serving to gather the data into images provided as the output of the neural network. For example, distinguishing between unwanted material and skin of a graft product would require only one filter, to gather the data into a single image for output as a monochrome image, while distinguishing between flesh, fascia and skin would require three filters.

According to varying aspects of the instant disclosure, an artificial neural network may adjust and improve kernel weights through automated learning or training, for example using training datasets based on user annotated images. In this manner, a configuration of the kernels 920 including the predetermined weight values 922, the pathway, and the stride in the convolution operations 900 may comprise a decision-making portion of the artificial neural network. In another aspect, the decision-making portion of the artificial neural network may include the configuration of the kernels and the rectified non-linear unit layer, with additional parameters as would be understood from consideration of the disclosed embodiments and features.

FIG. 9B is a three-dimensional diagram of another convolution operation 950 including an input matrix 960, a kernel 970, and a result 980. As in the convolution operation 900, the image data is shown as a simplified, two-dimensional input matrix 960 comprising color intensity values 962 for each pixel location of the captured image and the kernel 970 is shown as a simplified, two-dimensional matrix comprising a plurality of predetermined weight values 972 for transforming the color intensity values 962 of the input matrix 960. The kernel 970 may be applied to the input matrix 960 with a fixed pathway and stride. According to the two-dimensional illustration of FIG. 9B, the kernel 970 is depicted only at a first position 990.

In an example according to the depicted embodiment of FIG. 9B, a convolution operation for a three-dimensional matrix may be conceived from repeating the illustrated convolution operation 950, including convolution for each position of the kernel, three times, one for each input matrix of red, green, and blue. As discussed in other embodiments, entries 982 of the result 980 may cumulatively form feature maps and the feature maps may then be put through additional layers such as a rectified non-linear unit layer, additional convolution layers, and pooling layers.

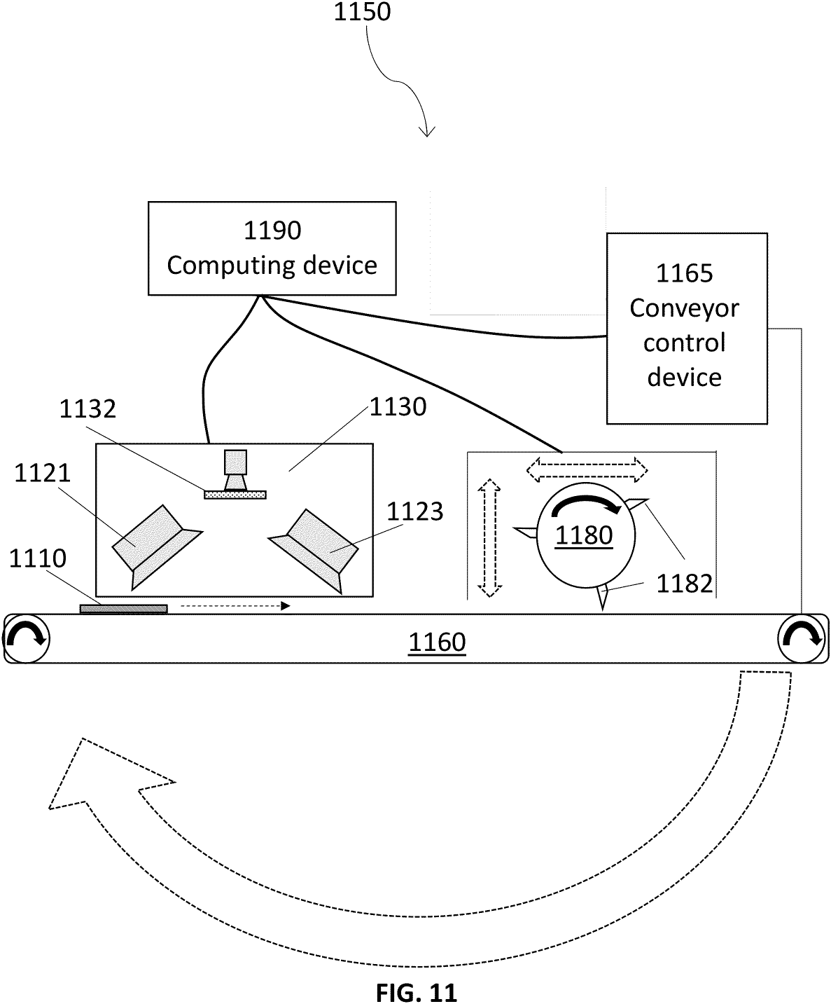

FIG. 11 is a schematic diagram of another embodiment of a system 1150 for automatically identifying material components of a graft product 1110 and removing unwanted materials therefrom. The system 1150 includes a first ultraviolet light source 1121 and a second ultraviolet light source 1123, each ultraviolet light source 1121, 1123 being configured to illuminate the graft product 1110 and an image capture device 1130 configured to capture an image of the graft product 1110. Image capture device 1130 may be configured to obtain still images or video images, or both, of the graft product as the graft product is conveyed in a direction transverse to the imaging direction of the image capture device 1130 by a conveyor 1160, on which the graft product 1110 lays.

The conveyor 1160, which may be a conveyor belt, is controlled by conveyor control device 1165, which may include a conveyor drive system. Conveyor control device 1165 can alter the speed and direction of the conveyor 1160. Additional, conveyor control device may be controlled by computing device 1190. The captured image includes an induced fluorescence of the graft product 1110. The image capture device 1130 may comprise, or the system 1150 may comprise, an optical filter 1132 configured to filter incoming light below a predetermined wavelength from entering the image capture device 1130. System 1150 includes a computer or computing device 1190.

Computing device 1190 receives image data from image capture device, for example, in the form of still image data or video image data. Computing device 1190 may be configured to process the image data using an artificial neural network, the artificial neural network being configured to localize and classify materials of the graft product from the image data as described in other embodiments herein. Based on the localization and classification of materials of the graft product 1110 from the image data, computing device 1190 may control a scraping or cutting device 1180 to remove unwanted materials from the graft product 1110. Embodiments of a scraping or cutting device 1180 may comprise a blade, reciprocating plane, cutter head, extrusion die, water jet, air jet, or other similar device for separating a thin layer of material from the graft product 1110. Preferably, the cutting device 1180 may remove material from only localized positions on the graft product 1110.

As illustrated in FIG. 11, the cutting device 1180 comprises a rotating cutter head including a plurality of cutting elements 1182. The cutting device 1180 may have a fixed position relative to the conveyor 1160 or may be configured to be movable in a predetermined area above the conveyor 1160, whether along the imaging direction towards or away from the conveyor 1160, along a direction perpendicular to a conveying direction of the graft product 1110, or along both directions. Alternatively, the cutting device 1180 may comprise a plurality of cutting elements 1182 distributed across the conveyor 1160, in the imaging direction, in the direction perpendicular to the conveying direction, or along both directions, for removing unwanted materials at predetermined positions or may be movable only between a plurality of fixed positions. In varying arrangements, the computing device 1190 may control the cutting device 1180 to remove unwanted materials from the graft product in only specific localized areas of the graft product to prevent damage to desired materials thereon, such as by repositioning the cutting device 1180 or activating cutting elements of the cutting device 1180 in only certain positions.

In some embodiments, the graft products 1110 may be secured to the conveyor 1160 by restraining devices, such as using mechanical clamping arms, a suction device of or in the conveyor 1160, or using similar device, to facilitate operation of the cutting device 1180 on the graft product 1110. Accordingly, a position of the graft product 1110, through control of the conveyor 1160 and any restraining devices, and the cutting device 1180 may be coordinated and adjusted by the computing device 1190 to precisely remove fascia and flesh from a graft product without damaging the skin with excessive scraping, cutting or pressure.

As further described herein, automatically identifying material components of a graft product 1110 and removing unwanted materials therefrom may include an iterative system or method. Accordingly, graft product 1110 may repeatedly be input to and output from system 1150. For this purpose, the graft product 1110 may be transported from cutting device 1180 to the image capture device 1130, whether manually transported or conveyed via a conveyor. In other embodiments, the system 1150 may be replicated along a single processing path, such that the graft product 1110 passes through a plurality of image capture devices 1130 and cutting devices 1180 in order to complete processing thereof. In other embodiments, the system 1150 may be provided with a further image capture device following the cutting device 1180, such that the efficacy of the cutting or scraping operation may be evaluated prior to determining a subsequent operation.

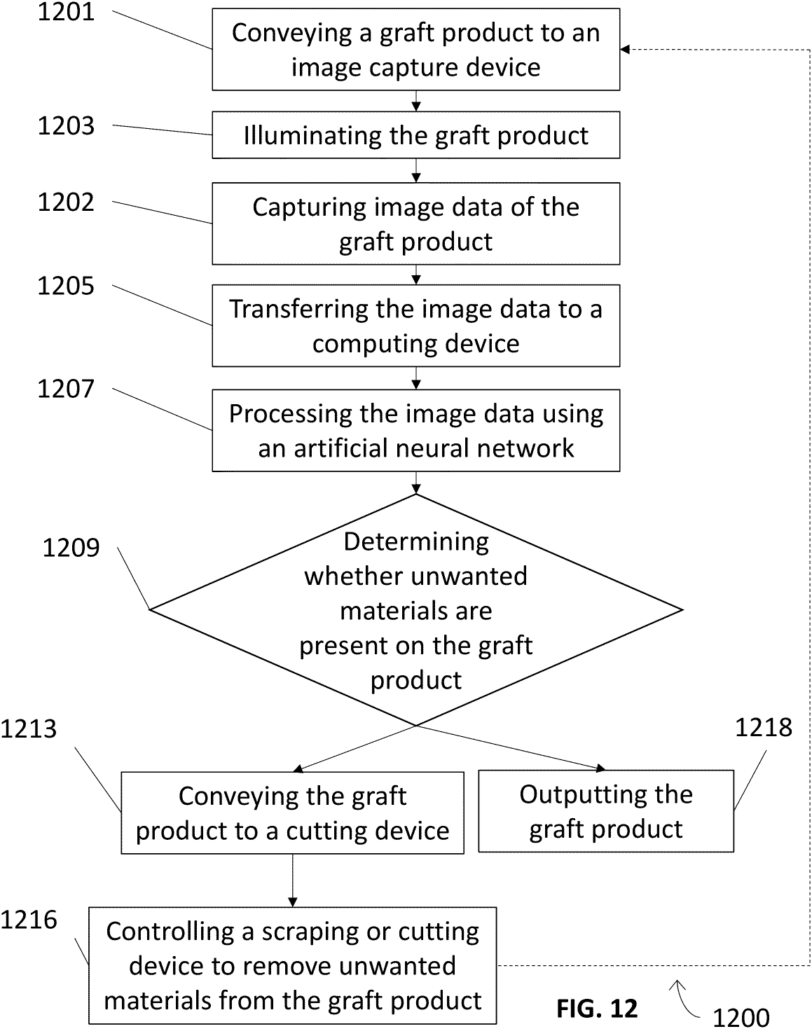

FIG. 12 is a flow diagram of a method 1200 for automatically identifying material components of a graft product and removing unwanted materials therefrom, such as may be performed using the system 1150. The method may comprise providing a graft product to a conveyor 1201 which conveys the graft product to an image capture device, illuminating the graft product using at least one ultraviolet light source 1203, capturing image data of the graft product 1202, transferring the image data to a computing device 1205, and processing the image data by the computing device using an artificial neural network 1207, the artificial neural network being configured to localize and classify materials of the graft product from the image data as described in other embodiments herein.

The method may further comprise determining whether unwanted materials are present on the graft product 1209. If no unwanted materials are identified, the method may proceed by outputting the graft product, whether by conveying the graft product or providing an indication to a user that the graft product is free of unwanted materials 1218. Where unwanted materials are identified on the graft product, the method may proceed by conveying the graft product to a cutting device 1213 and, based on the localization and classification of materials of the graft product from the artificial neural network, controlling a scraping or cutting device to remove unwanted materials from the graft product 1216, such as by using position information from the computing device to position or activate the cutting device at certain areas of the graft product classified as unwanted materials as the graft product is conveyed to or by the cutting device. Following operation of the cutting device, the method may be repeated 1218 using the same system or with the duplication of some or all components of the same system in a processing line. In some embodiments, where all unwanted materials were successfully removed in a previous step, only the steps of providing a graft product to a conveyor 1201 which conveys the graft product to an image capture device, illuminating the graft product using at least one ultraviolet light source 1203, capturing image data of the graft product 1202, transferring the image data to a computing device 1205, and processing the image data by the computing device using an artificial neural network 1207 may be repeated.

Embodiments of the present disclosure may comprise or utilize a special-purpose or general-purpose computer system that includes computer hardware, such as, for example, one or more processors and system memory, as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the disclosure.

Transmission media can include a network and/or data links which can be used to carry program code in the form of computer-executable instructions or data structures, and which can be accessed by a general-purpose or special-purpose computer system. A “network” may be defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions may comprise, for example, instructions and data which, when executed by one or more processors, cause a general-purpose computer system, special-purpose computer system, or special-purpose processing device to perform a certain function or group of functions. Computer-executable instructions may be, for example, binaries, intermediate format instructions such as assembly language, or even source code.

The disclosure of the present application may be practiced in network computing environments with many types of computer system configurations, including, but not limited to, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

The disclosure of the present application may also be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

By providing a system and method for identifying material components on graft products according to disclosed embodiments, the problem of existing 2D image recognition and manual identification approaches being expensive, time consuming, and poorly adapted to the problem of differentiating visually similar materials such as fascia, flesh and skin within a graft product is addressed. The disclosed embodiments advantageously provide a system and method that identifies and provides increased accuracy, speed and consistency in distinguishing between material components of graft products in order to provide actionable and quantifiable insights to a technician or automated processing system.

Various features of the disclosure may be better understood by reference to a specific example of a method for identifying material components on graft products according to the current disclosure, as detailed in the attached Appendix, the Appendix being expressly incorporated herein by this reference. The example provided is illustrative in nature of a single application of principles according to the disclosure and is not intended to be limiting. Notably, the Appendix illustrates a severely reduced scale of neural network for processing an input image in the form of a 4×4×3 frame, and many values are assumed for simplicity.

Not necessarily all such objects or advantages may be achieved under any embodiment of the disclosure. Those skilled in the art will recognize that the disclosure may be embodied or carried out to achieve or optimize one advantage or group of advantages as taught without achieving other objects or advantages as taught or suggested.

The skilled artisan will recognize the interchangeability of various components from different embodiments described. Besides the variations described, other equivalents for each feature can be mixed and matched by one of ordinary skill in this art to construct or use a system or method for identifying material components of a graft product under principles of the present disclosure. Therefore, the embodiments described may be adapted to material identification and localization for fascia, flesh, scales, skin or any other suitable material on a graft product.

### Combinability of Embodiments and Features

This disclosure provides various examples, embodiments, and features which, unless expressly stated or which would be mutually exclusive, should be understood to be combinable with other examples, embodiments, or features described herein.

In addition to the above, further embodiments and examples include the following:

1. A system for identifying material components on graft products, the system comprising: an image capture device configured to obtain image data of a graft product; and a processor configured to process the image data using an artificial neural network, the artificial neural network being configured to localize and classify materials of the graft product from the image data.

2. The system according to any or a combination of 1 above or 3-19 below, wherein the image capture device comprises an ultraviolet light source, an optical filter and an image sensor.

3. The system according to any or a combination of 1-2 above or 4-19 below, wherein the ultraviolet light source is configured to emit light having a wavelength of 365 nm to 395 nm.

4. The system according to any or a combination of 1-3 above or 5-19 below, wherein the optical filter comprises a long-pass filter configured with a cut-on wavelength of 435 nm.

5. The system according to any or a combination of 1-4 above or 6-19 below, wherein the optical filter has a transmittance of 85% for wavelengths greater than 435 nm.

6. The system according to any or a combination of 1-5 above or 7-19 below, wherein the processor is configured to divide the image data into a plurality of image tiles.

7. The system according to any or a combination of 1-6 above or 8-19 below, wherein the plurality of image tiles each have an identical size.

8. The system according to any or a combination of 1-7 above or 9-19 below, wherein the plurality of image tiles comprises 35 image tiles.

9. The system according to any or a combination of 1-8 above or 10-19 below, wherein the graft product comprises piscine skin having unwanted materials thereon, including at least one of fascia and flesh.

10. The system according to any or a combination of 1-9 above or 11-19 below, wherein the artificial neural network comprises a convolutional neural network.

11. The system according to any or a combination of 1-10 above or 12-19 below, wherein the convolutional neural network comprises a stepped contracting path, each step of the stepped contracting path comprising: a first contracting convolutional layer; a second contracting convolutional layer; a first contracting rectifier layer following the first contracting convolutional layer; a second contracting rectifier layer following the second contracting convolutional layer; a storage operation that stores an output following the second contracting rectifier layer; and a pooling layer following the storage operation.

12. The system according to any or a combination of 1-11 above or 13-19 below, wherein the convolutional neural network comprises a stepped expanding path, each step of the stepped expanding path comprising: a first expanding convolutional layer; a second expanding convolutional layer; a first expanding rectifier layer following the first expanding convolutional layer; a second expanding rectifier layer following the second expanding convolutional layer; an up-sampling layer following the second expanding rectifier layer; and a concatenation operation that stacks an output of the up-sampling layer with the stored output of the stepped contracting path.

13. The system according to any or a combination of 1-12 above or 14-19 below, wherein the stepped contracting path and the stepped expanding path comprise a same number of steps.

14. The system according to any or a combination of 1-13 above or 15-19 below, wherein the stepped contracting path and the stepped expanding path each comprise six steps.

15. The system according to any or a combination of 1-14 above or 16-19 below, wherein an output step comprises: a first output convolutional layer; a second output convolutional layer; a first output rectifier layer following the first output convolutional layer; a second output rectifier layer following the second output convolutional layer; and a sigmoid layer following the second output rectifier layer.

16. The system according to any or a combination of 1-15 above or 17-19 below, wherein the convolutional neural network is configured to output an image defining an area of each material feature of the graft product.

17. The system according to any or a combination of 1-16 above or 18-19 below, wherein the optical filter is configured with a cut-on wavelength of 400 nm to 600 nm.

18. The system according to any or a combination of 1-17 above or 19 below, wherein the plurality of image tiles each have equal dimensions of 512×512 pixels.

19. The system according to any or a combination of 1-18 above, wherein the image data is resized prior to being divided into the plurality of image tiles.

20. A method for identifying material components on graft products, the method comprising the steps of: capturing with an image capture device image data of a graft product; and using a processor to process the image data using an artificial neural network to localize and classify materials of the graft product from the image data.

21. The method according to any or a combination of 20 above or 22-38 below, wherein capturing the image data of the graft product further comprises: irradiating the graft product with an ultraviolet light source; filtering light emitted and reflected by the graft product with an optical filter of the image capture device; and capturing the filtered light using an image sensor of the image capture device.

22. The method according to any or a combination of 20-21 above or 23-38 below, wherein the ultraviolet light source is configured to emit light having a wavelength of 365 nm to 395 nm.

23. The method according to any or a combination of 20-22 above or 24-38 below, wherein the optical filter comprises a long-pass filter configured with a cut-on wavelength of 435 nm.

24. The method according to any or a combination of 20-23 above or 25-38 below, wherein the optical filter has a transmittance of 85% for wavelengths greater than 435 nm.

25. The method according to any or a combination of 20-24 above or 26-38 below, further comprising dividing the image data into a plurality of image tiles using the processor.

26. The method according to any or a combination of 20-25 above or 27-38 below, wherein the plurality of image tiles each have an identical size.

27. The method according to any or a combination of 20-26 above or 28-38 below, wherein the plurality of image tiles comprises 35 image tiles.

28. The method according to any or a combination of 20-27 above or 29-38 below, wherein the graft product comprises piscine skin having unwanted materials thereon, including at least one of fascia and flesh.

29. The method according to any or a combination of 20-28 above or 30-38 below, wherein the artificial neural network comprises a convolutional neural network.

30. The method according to any or a combination of 20-29 above or 31-38 below, further comprising inputting each of the plurality of image tiles to a stepped contracting path of the artificial neural network, each step of the contracting path comprising: a first contracting convolutional layer; a second contracting convolutional layer; a first contracting rectifier layer following the first contracting convolutional layer; a second contracting rectifier layer following the second contracting convolutional layer; a storage operation that stores an output following the second contracting rectifier layer; and a pooling layer following the storage operation.

31. The method according to any or a combination of 20-30 above or 32-38 below, further comprising inputting each of the plurality of image tiles to a symmetric stepped expanding path of the artificial neural network, each step of the stepped expanding path comprising: a first expanding convolutional layer; a second expanding convolutional layer; a first expanding rectifier layer following the first expanding convolutional layer; a second expanding rectifier layer following the second expanding convolutional layer; an up-sampling layer following the second expanding rectifier layer; and a concatenation operation that stacks an output of the up-sampling layer with the stored output of the stepped contracting path.

32. The method according to any or a combination of 20-31 above or 33-38 below, wherein the stepped contracting path and the stepped expanding path comprise a same number of steps.

33. The method according to any or a combination of 20-32 above or 34-38 below, wherein the stepped contracting path and the stepped expanding path each comprise six steps.

34. The method according to any or a combination of 20-33 above or 35-38 below, further comprising inputting each of the plurality of image tiles to an output step of the artificial neural network, the output step comprising: a first output convolutional layer; a second output convolutional layer; a first output rectifier layer following the first output convolutional layer; a second output rectifier layer following the second output convolutional layer; and a sigmoid layer following the second output rectifier layer.

35. The method according to any or a combination of 20-34 above or 36-38 below, further comprising outputting an image defining an area of each material feature of the graft product following the output step of the artificial neural network.

36. The method according to any or a combination of 20-35 above or 37-38 below, wherein the optical filter is configured with a cut-on wavelength of 400 nm to 600 nm.

37. The method according to any or a combination of 20-36 above or 38 below, wherein the plurality of image tiles each have equal dimensions of 512×512 pixels.

38. The method according to any or a combination of 20-37 above, wherein the image data is resized prior to being divided into the plurality of image tiles.

39. A non-transitory hardware storage device having stored thereon computer executable instructions which, when executed by one or more processors of a computer, configure the computer to perform at least the following: capture with an image capture device image data of a graft product; and use a processor to process the image data using an artificial neural network to localize and classify materials of the graft product from the image data.

Although the system or method for identifying material components on graft products has been disclosed in certain preferred embodiments and examples, it therefore will be understood by those skilled in the art that the present disclosure extends beyond the disclosed embodiments to other alternative embodiments and/or uses of the system or method for identifying material components on graft products and obvious modifications and equivalents. It is intended that the scope of the present system or method for identifying material components on graft products disclosed should not be limited by the disclosed embodiments described above, but should be determined only by a fair reading of the claims that follow.

1. A system for identifying material components on graft products, the system comprising:
an image capture device configured to obtain image data of a graft product; and
a processor configured to process the image data using an artificial neural network, the artificial neural network being configured to localize and classify materials of the graft product from the image data.

2. The system according to claim 1, wherein the image capture device comprises an ultraviolet light source, an optical filter, and an image sensor.

3. The system according to claim 2, wherein the ultraviolet light source is configured to emit light having a wavelength of 365 nm to 395 nm.

4. The system according to claim 2, wherein the optical filter comprises a long-pass filter configured with a cut-on wavelength of 435 nm.

5. The system according to claim 2, wherein the optical filter has a transmittance of 85% for wavelengths greater than 435 nm.

6. The system according to claim 1, wherein the processor is configured to divide the image data into a plurality of image tiles.

7. The system according to claim 6, wherein each of the plurality of image tiles has an identical size.

8. The system according to claim 1, wherein the graft product comprises piscine skin having unwanted materials thereon, including at least one of fascia and flesh.

9. The system according to claim 1, wherein the artificial neural network comprises a convolutional neural network.

10. The system according to claim 9, wherein the convolutional neural network comprises a stepped contracting path, each step of the stepped contracting path comprising:
a first contracting convolutional layer;
a second contracting convolutional layer;
a first contracting rectifier layer following the first contracting convolutional layer;
a second contracting rectifier layer following the second contracting convolutional layer;
a storage operation that stores an output following the second contracting rectifier layer; and
a pooling layer following the storage operation.

11. The system according to claim 10, wherein the convolutional neural network comprises a stepped expanding path, each step of the stepped expanding path comprising:
a first expanding convolutional layer;
a second expanding convolutional layer;
a first expanding rectifier layer following the first expanding convolutional layer;
a second expanding rectifier layer following the second expanding convolutional layer;
an up-sampling layer following the second expanding rectifier layer; and
a concatenation operation that stacks an output of the up-sampling layer with the stored output of the stepped contracting path.

12. The system according to claim 11, wherein the stepped contracting path and the stepped expanding path comprise a same number of steps.

13. The system according to claim 11, wherein the stepped contracting path and the stepped expanding path each comprise six steps.

14. The system according to claim 1, wherein an output step comprises:
a first output convolutional layer;
a second output convolutional layer;
a first output rectifier layer following the first output convolutional layer;
a second output rectifier layer following the second output convolutional layer; and
a sigmoid layer following the second output rectifier layer.

15. The system according to claim 9, wherein the convolutional neural network is configured to output an image defining an area of each material feature of the graft product.

16. The system according to claim 2, wherein the optical filter is configured with a cut-on wavelength of 400 nm to 600 nm.

17. The system according to claim 6, wherein the processor is configured to resize the image data prior to dividing the image data into the plurality of image tiles.

18. A method for identifying material components on graft products, the method comprising the steps of:
capturing with an image capture device image data of a graft product; and
using a processor to process the image data using an artificial neural network to localize and classify materials of the graft product from the image data.

19. The method according to claim 18, wherein capturing the image data of the graft product further comprises:
irradiating the graft product with an ultraviolet light source;
filtering light emitted and reflected by the graft product with an optical filter of the image capture device; and
capturing the filtered light using an image sensor of the image capture device.

20. A non-transitory hardware storage device having stored thereon computer executable instructions which, when executed by one or more processors of a computer, configure the computer to perform at least the following:
capture with an image capture device image data of a graft product; and
process the image data using an artificial neural network to localize and classify materials of the graft product from the image data.
